(19) United States
(12) Patent Application Publication
(10) Pub. No.: US 2026/0253306 A1
(43) Pub. Date: Aug. 27, 2026

(54) INFORMATION PROCESSING SYSTEM, INFORMATION PROCESSING METHOD, AND INFORMATION PROCESSING PROGRAM

(71) Applicant: NATIONAL INSTITUTE OF INFORMATION AND COMMUNICATIONS TECHNOLOGY, Tokyo (JP)

(72) Inventors: Michal Joachimczak, Koganei-shi, Tokyo (JP); Juan Liu, Koganei-shi, Tokyo (JP); Hiroshi Ando, Koganei-shi, Tokyo (JP); Kiyotaka Uchimoto, Koganei-shi, Tokyo (JP)

(21) Appl. No.: 18/726,882

(22) PCT Filed: Dec. 22, 2022
(86) PCT No.: PCT/JP2022/047439

§ 371 Date: Jul. 5, 2024

(30) Foreign Application Priority Data
Jan. 6, 2022 (JP) 2022-001280

(51) Int. Cl. G06T 15/04; G06T 7/70; G06T 17/20

(52) U.S. Cl. CPC G06T 15/04; G06T 7/70; G06T 17/20; G06T 2200/08; G06T 2207/10016; G06T 2207/20212; G06T 2207/30201

(57) ABSTRACT

A facial texture reconstruction unit reconstructs a texture of a face from a 2D video of a person. A facial shape reconstruction unit reconstructs a 3D shape of the face from the 2D video. A pose estimation unit estimates a pose of the person from the 2D video. A shape integration unit reconstructs a 3D shape of the body corresponding to the estimated pose based on the 3D shape data, and integrates the reconstructed 3D shape of the body and the reconstructed 3D shape of the face to reconstruct a 3D shape of the person. A texture reconstruction unit reconstructs a texture image of the person by blending, with an image of the reconstructed texture of the face, a texture image included in the texture data and a model generation unit generates a 3D model of the person based on the 3D shape and the texture image of the person.

### TECHNICAL FIELD

The present invention relates to an information processing system, an information processing method, and an information processing program each for reproducing a 3D model.

### BACKGROUND

There has been proposed a technology for providing remote communication in which a 3D model representing a person in a more realistic manner is reconstructed, the reconstructed 3D model is transmitted to a remote location, and a 3D space is shared using an XR (VR/AR/MR) technology.

For example, M. Joachimczak, J. Liu, H. Ando, 2017. Real Time Mixed Reality Telepresence via 3D Reconstruction with HoloLens and Commodity Depth Sensors. In Proceedings of 19th ACM International Conference on Multimodal Interaction (ICMI'17). ACM, New York, NY, USA, 2 pages. https://doi.org/10.1145/3136755.3143031 discloses a system in which 3D shape and texture of a person are acquired using a depth sensor, the acquired 3D shape and texture are transmitted to a remote location, and communication can be performed in a state in which a 3D model of the person is superimposed on a real space using an MR (Mixed Reality) headset. Further, the 3D shape of the person may be acquired using a plurality of cameras.

In the above-described prior art, the depth sensor or the plurality of cameras are required, which may result in a complicated device configuration. Therefore, there has been required a method of acquiring 3D shape and texture of a person from a 2D video of the person captured by one camera and transmitting a 3D model of the person to a remote location so as to reproduce the 3D model.

### SUMMARY OF INVENTION

One object of the present invention is to provide a configuration by which a 3D model of a person can be reproduced with a more simplified configuration.

An information processing system according to an embodiment includes: a camera; a storage unit that stores 3D shape data and texture data each prepared in advance, the 3D shape data indicating a 3D shape of a body, the texture data indicating a texture of the body; a facial texture reconstruction unit that reconstructs a texture of a face from a 2D video of a person captured by the camera; a facial shape reconstruction unit that reconstructs a 3D shape of the face from the 2D video of the person captured by the camera; a pose estimation unit that estimates a pose of the person from the 2D video of the person captured by the camera; a shape integration unit that reconstructs a 3D shape of the body corresponding to the estimated pose based on the 3D shape data and that integrates the reconstructed 3D shape of the body and the reconstructed 3D shape of the face so as to reconstruct a 3D shape of the person captured by the camera; a texture reconstruction unit that reconstructs a texture image of the person captured by the camera by blending, with an image of the reconstructed texture of the face, a texture image included in the texture data; and a model generation unit that generates, based on the 3D shape of the person captured by the camera and the texture image of the person captured by the camera, a 3D model of the person captured by the camera.

The texture data may include: a texture image corresponding to the reconstructed 3D shape of the body and a texture image corresponding to the reconstructed 3D shape of the face; and a texture map corresponding to the reconstructed 3D shape of the body and a texture map corresponding to the reconstructed 3D shape of the face.

The information processing system may further include: a body shape reconstruction unit that reconstructs the 3D shape of the body from a plurality of 2D videos of the person captured by the camera; a head shape reconstruction unit that reconstructs a 3D shape of a head from the plurality of 2D videos of the person captured by the camera; and a texture integration unit that determines correspondence between the reconstructed 3D shape of the body and the reconstructed 3D shape of the head, that determines, based on the determined correspondence between the 3D shapes, correspondence between the texture map corresponding to the 3D shape of the body and the texture map corresponding to the 3D shape of the head, and that generates, based on the determined correspondence between the texture maps, a texture image corresponding to the 3D shape of the head from the texture image corresponding to the 3D shape of the body.

The shape integration unit may integrate the reconstructed 3D shape of the body and the reconstructed 3D shape of the face based on the texture maps included in the texture data.

The model generation unit may integrate the 3D shape of the person and the texture image of the person based on the texture maps included in the texture data.

The texture reconstruction unit may superimpose, on the texture image included in the texture data, a result of passage, through a mask, of the texture image of the person captured by the camera.

The mask may be configured to continuously change a degree of passage.

A partial video corresponding to a window set in the 2D video of the person captured by the camera may be input to each of the facial texture reconstruction unit and the facial shape reconstruction unit. The information processing system may further include a stabilization unit that temporally smoothes a position of the person in the 2D video so as to set the window.

The texture integration unit may generate the texture data by integrating the texture image corresponding to the 3D shape of the body and the texture image corresponding to the 3D shape of the head and integrating the texture map corresponding to the 3D shape of the body and the texture map corresponding to the 3D shape of the head.

An information processing method according to another embodiment includes: reconstructing a texture of a face from a 2D video of a person captured by a camera; reconstructing a 3D shape of the face from the 2D video of the person captured by the camera; estimating a pose of the person from the 2D video of the person captured by the camera; reconstructing a 3D shape of the body corresponding to the estimated pose based on 3D shape data indicating a 3D shape of the body, the 3D shape data being prepared in advance; integrating the reconstructed 3D shape of the body and the reconstructed 3D shape of the face so as to reconstruct a 3D shape of the person captured by the camera; reconstructing a texture image of the person captured by the camera by blending, with an image of the reconstructed texture of the face, a texture image included in texture data indicating a texture of the body, the texture data being prepared in advance; and generating, based on the 3D shape of the person captured by the camera and the texture image of the person captured by the camera, a 3D model of the person captured by the camera.

According to still another embodiment, there is provided an information processing program for causing a computer to perform the above-described method.

According to the present invention, a 3D model of a person can be reproduced with a more simplified configuration.

### BRIEF DESCRIPTION OF DRAWINGS

FIG. 1 is a schematic diagram showing an exemplary system configuration of an information processing system according to the present embodiment.

FIG. 2 is a schematic diagram showing an exemplary hardware configuration of an information processing device included in the information processing system according to the present embodiment.

FIG. 3 is a flowchart showing a process procedure in an initial model construction stage of the information processing system according to the present embodiment.

FIG. 4 is a flowchart showing a process procedure in a 3D model reproduction stage of the information processing system according to the present embodiment.

FIG. 5 is a schematic diagram showing a functional configuration example for implementing the initial model construction stage of the information processing system according to the present embodiment.

FIG. 6 is a diagram showing exemplary data generated in the initial model construction stage of the information processing system according to the present embodiment.

FIG. 7 is a schematic diagram for illustrating processes for texture integration in the initial model construction stage of the information processing system according to the present embodiment.

FIG. 8 is a schematic diagram showing a functional configuration example for implementing the 3D model reproduction stage of the information processing system according to the present embodiment.

FIG. 9 is a diagram showing exemplary data generated in the 3D model reproduction stage of the information processing system according to the present embodiment.

FIG. 10 is a schematic diagram for illustrating a blending process in the information processing system according to the present embodiment.

FIG. 11 is a schematic diagram showing another exemplary system configuration of the information processing system according to the present embodiment.

### DETAILED DESCRIPTION

Embodiments of the present invention will be described in detail with reference to figures. It should be noted that the same or corresponding portions in the figures are denoted by the same reference characters and will not be described repeatedly.

In the present specification, the term “three-dimension” or “three-dimensional” is abbreviated as “3D”, and the term “two-dimension” or “two-dimensional” is abbreviated as “2D”.

### A. System Configuration

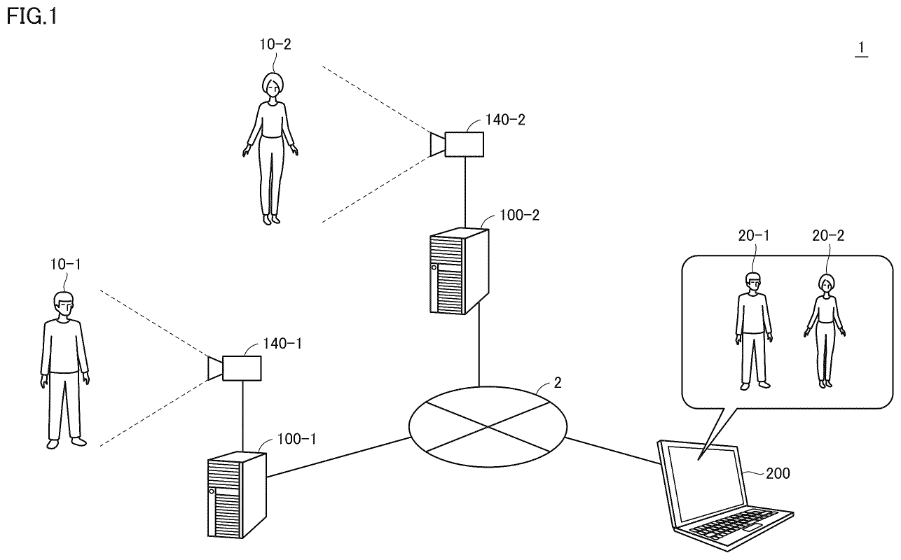

FIG. 1 is a schematic diagram showing an exemplary system configuration of an information processing system 1 according to the present embodiment. FIG. 1 shows a configuration example in which information processing devices 100-1, 100-2 (hereinafter, also collectively referred to as “information processing device 100”) and an information processing device 200 are connected via a network 2, for example. A camera 140-1 is connected to information processing device 100-1, and a camera 140-2 is connected to information processing device 100-2.

Information processing device 100 has acquired an initial model of a person 10 in advance. Information processing device 100 reproduces a 3D model of person 10 by continuously capturing person 10 using camera 140. It should be noted that the reproduced 3D model is changed in real time with motion and facial expression of captured person 10 being reflected. The reproduced 3D model of person 10 is also referred to as a “3D avatar” or is simply referred to as an “avatar”.

In the example shown in FIG. 1, a person 10-1 is present within a visual field range of a camera 140-1, and a person 10-2 is present within a visual field range of a camera 140-2. Information processing device 100-1 reproduces a 3D model 20-1 of person 10-1 on a screen of information processing device 200 or the like by capturing person 10-1. Similarly, information processing device 100-2 reproduces a 3D model 20-2 of person 10-2 on the screen of information processing device 200 or the like by capturing person 10-2. 3D models 20-1, 20-2 each reproduced on the screen of information processing device 200 can be present in any 3D space.

### B. Hardware Configuration Example

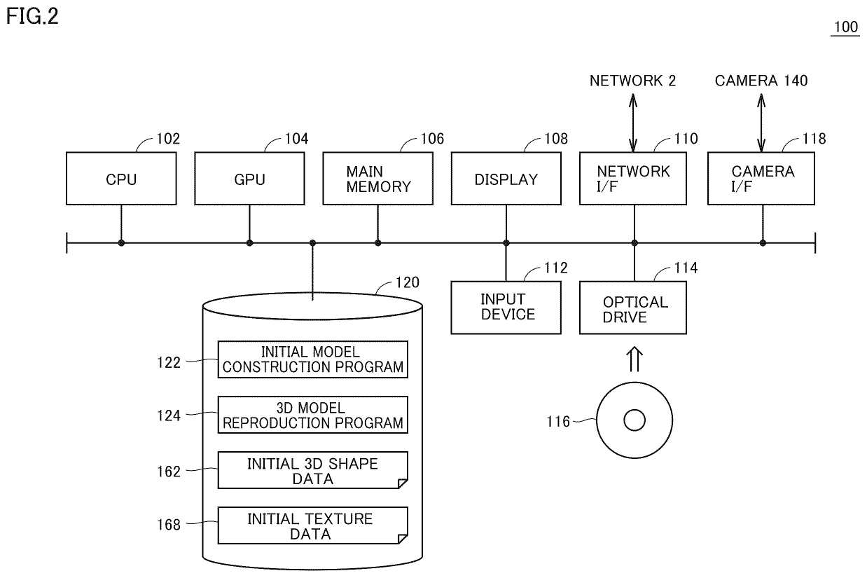

FIG. 2 is a schematic diagram showing an exemplary hardware configuration of each information processing device 100 included in information processing system 1 according to the present embodiment. Typically, information processing device 100 can be implemented using a general-purpose computer.

Referring to FIG. 2, information processing device 100 includes, as main hardware components, a CPU 102, a GPU 104, a main memory 106, a display 108, a network interface (I/F) 110, an input device 112, an optical drive 114, a camera interface (I/F) 118, and a storage 120.

CPU 102 and/or GPU 104 are each a processor that perform an information processing method according to the present embodiment. A plurality of CPUs 102 and a plurality of GPUs 104 may be disposed, or CPU 102 and GPU 104 may each have a plurality of cores.

Main memory 106 is a storage region for temporarily storing (or caching) a program code, work data, or the like when the processor (CPU 102 and/or GPU 104) performs a process, and is constituted of a volatile storage device such as a DRAM (Dynamic Random Access Memory) or an SRAM (Static Random Access Memory), for example.

Display 108 is a display unit that outputs a user interface for processes, a processing result, and the like, and is constituted of, for example, an LCD (liquid crystal display), an organic EL (electroluminescence) display, or the like.

Network interface 110 exchanges data with any information processing device or the like connected to network 2.

Input device 112 is a device that receives an instruction, an operation, or the like from a user, and is constituted of, for example, a keyboard, a mouse, a touch panel, a pen, and/or the like.

Optical drive 114 reads information stored in an optical disk 116 such as a CD-ROM (compact disc read only memory) or a DVD (digital versatile disc) and outputs the information to another component. Optical disk 116 is an exemplary non-transitory recording medium, and distributes various programs stored in a non-volatile manner. When optical drive 114 reads the program from optical disk 116 and installs the program in storage 120 or the like, the computer functions as information processing device 100. Therefore, the subject matter of the present invention may be the program itself installed in storage 120 or the like, or may be the recording medium such as optical disk 116 storing the program for implementing a function and a process according to the present embodiment.

As an exemplary non-transitory recording medium, FIG. 2 shows an optical recording medium such as optical disk 116; however, it is not limited thereto and a semiconductor recording medium such as a flash memory, a magnetic recording medium such as a hard disk or a storage tape, or a magneto-optical recording medium such as an MO (magneto-optical disk) may be used.

Camera interface 118 acquires a video captured by camera 140, and provides camera 140 with a command regarding capturing.

Storage 120 stores a program and data necessary to function the computer as information processing device 100. For example, storage 120 is constituted of a non-volatile storage device such as a hard disk or a solid state drive (SSD).

More specifically, storage 120 stores: an OS (operating system) (not shown); an initial model construction program 122 for implementing a process (initial model construction stage) of constructing an initial model; and a 3D model reproduction program 124 for implementing a process (3D model reproduction stage) of generating a 3D model. These information processing programs cause information processing device 100, which is an exemplary computer, to perform various processes according to the present embodiment.

Further, initial 3D shape data 162 and initial texture data 168 each generated in the initial model construction stage may be stored in storage 120. That is, storage 120 corresponds to a storage unit that stores 3D shape data 126 and initial texture data 168 each prepared in advance, 3D shape data 126 indicating a 3D shape of a body, initial texture data 168 (texture data) indicating a texture of the body.

FIG. 2 shows an example in which information processing device 100 is constituted of a single computer; however, it is not limited thereto and a plurality of computers connected via a computer network may be explicitly or implicitly coordinated to implement the information processing method according to the present embodiment.

All or part of the functions implemented by the processor (CPU 102 and/or GPU 104) executing the programs may be implemented using a hard-wired circuit such as an integrated circuit. For example, an ASIC (application specific integrated circuit), an FPGA (field-programmable gate array), or the like may be used to implement all or part of the functions.

One having ordinary skill in the art can implement information processing device 100 according to the present embodiment by appropriately using a technology suitable in an era in which the present invention is implemented.

Further, the hardware configuration of information processing device 200 included in information processing system 1 is also the same as that of FIG. 2, and therefore will not be described in detail repeatedly.

### C. Process Procedure for Reproducing 3D Model

In order to reproduce the 3D model, typically, the process (initial model construction stage) of constructing an initial model and the process (3D model reproduction stage) of generating a 3D model are performed.

In the present specification, the term “texture data” is a term collectively representing a texture image and a texture map.

### c1: Initial Model Construction Stage

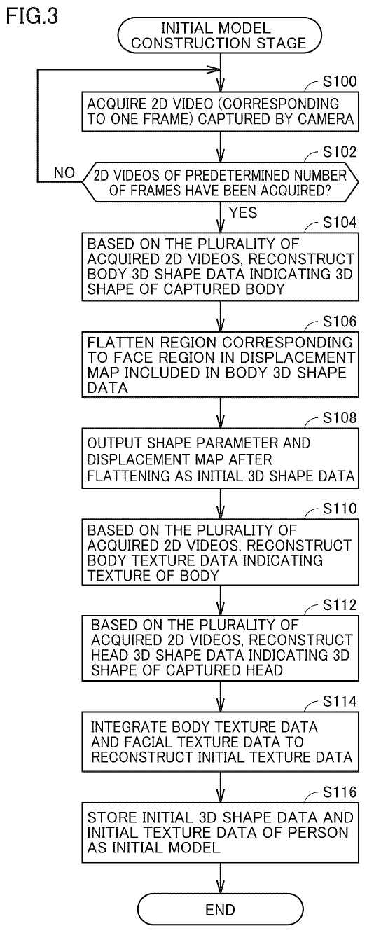

FIG. 3 is a flowchart showing a process procedure in the initial model construction stage of information processing system 1 according to the present embodiment. Each process shown in FIG. 3 is typically implemented by the processor of information processing device 100 executing a program (initial model construction program 122 shown in FIG. 2).

Referring to FIG. 3, information processing device 100 acquires a 2D video (corresponding to one frame) captured by camera 140 (step S100). Information processing device 100 determines whether or not 2D videos of a predetermined number of frames have been acquired (step S102). When the 2D videos of the predetermined number of frames have not been acquired (NO in step S102), the processes of step S100 and the subsequent step are repeated.

It should be noted that information processing device 100 may start capturing by camera 140 in response to explicitly receiving an instruction from the user or may repeat capturing at a predetermined cycle.

Next, based on the plurality of acquired 2D videos (multiple-viewpoint videos 144), information processing device 100 reconstructs body 3D shape data 160 indicating a 3D shape of the captured body (step S104). Then, information processing device 100 flattens a region corresponding to a face region in a displacement map included in body 3D shape data 160 (step S106). Finally, a shape parameter as well as the displacement map after the flattening are output as initial 3D shape data 162 (step S108).

Further, based on the plurality of acquired 2D videos (multiple-viewpoint videos 144), information processing device 100 reconstructs body texture data (body texture image 1642 and body texture map 1644) indicating a texture of the body (step S110).

Further, based on the plurality of acquired 2D videos (multiple-viewpoint videos 144), information processing device 100 reconstructs head 3D shape data 167 indicating a 3D shape of the captured head (step S112).

In information processing device 100, texture integration unit 158 integrates body texture data 164 and facial texture data 166 to reconstruct initial texture data 168 (initial texture image 1682 and initial texture map 1684) (step S114).

It should be noted that the processes of steps S104 to S108 and the processes of steps S110 to S114 may be performed in any order. Alternatively, these processes may be performed in parallel.

Finally, information processing device 100 stores initial 3D shape data 162 and initial texture data 168 of the person as an initial model (step S116).

### c2: 3D Model Reproduction Stage

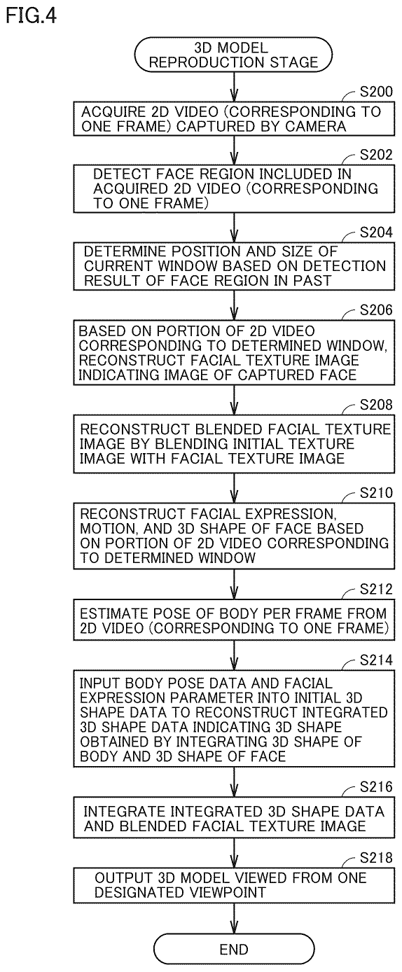

FIG. 4 is a flowchart illustrating a process procedure in the 3D model reproduction stage of information processing system 1 according to the present embodiment. Each process shown in FIG. 4 is typically implemented by the processor of information processing device 100 executing a program (3D model reproduction program 124 shown in FIG. 2).

Referring to FIG. 4, information processing device 100 acquires a 2D video (corresponding to one frame) captured by camera 140 (step S200).

Information processing device 100 detects a face region included in the acquired 2D video (corresponding to one frame) (step S202), and determines position and size of a current window based on a detection result of the face region in past (step S204).

Based on a portion of the 2D video corresponding to the determined window, information processing device 100 reconstructs a facial texture image 1666 indicating an image of the captured face (step S206). That is, information processing device 100 reconstructs a texture of the face from the 2D video of the person captured by camera 140.

Then, information processing device 100 reconstructs a blended facial texture image 1824 by blending, with facial texture image 1666, initial texture image 1682 (initial facial texture image 1686) reconstructed in the initial model construction stage (step S208). That is, information processing device 100 reconstructs the texture image (blended facial texture image 1824) of the person captured by camera 140 by blending, with an image of the reconstructed texture of the face (facial texture image 1666), the texture image (initial facial texture image 1686) included in the texture data indicating the texture of the body, the texture data being prepared in advance.

Further, information processing device 100 reconstructs parameters (facial expression parameters 184) respectively indicating facial expression, motion, and 3D shape of the face based on the portion of the 2D video corresponding to the determined window (step S210). That is, information processing device 100 reconstructs the 3D shape of the face from the 2D video of the person captured by camera 140.

Further, information processing device 100 estimates a pose (posture) of the body per frame from the 2D video (corresponding to one frame) (step S212). That is, information processing device 100 estimates the pose of the person from the 2D video of the person captured by camera 140. The estimated pose is output per frame as body pose data 186.

The process of step S210 and the process of step S212 may be performed in parallel or may be performed in series. The processes may be performed in any order.

Information processing device 100 inputs body pose data 186 and facial expression parameters 184 into initial 3D shape data 162 reconstructed in the initial model construction stage, thereby reconstructing integrated 3D shape data 188 indicating a 3D shape obtained by integrating the 3D shape of the body and the 3D shape of the face (step S214). More specifically, information processing device 100 reconstructs the 3D shape (integrated 3D shape data 188) of the body corresponding to the estimated pose based on the 3D shape data (initial 3D shape data 162) indicating the 3D shape of the body, the 3D shape data being prepared in advance. Further, information processing device 100 integrates the reconstructed 3D shape of the body and the reconstructed 3D shape of the face so as to reconstruct the 3D shape (integrated 3D shape data 188) of the person captured by camera 140.

It should be noted that the processes of steps S202 to S208 and the processes of steps S210 to S214 may be performed in parallel or may be performed in series. The processes may be performed in any order.

Information processing device 100 integrates integrated 3D shape data 188 and blended facial texture image 1824 (step S216), and outputs a 3D model viewed from one designated viewpoint (step S218). That is, based on the 3D shape of the person captured by camera 140 and the texture image of the person captured by camera 140, information processing device 100 generates a 3D model 190 of the person captured by camera 140.

The processes of steps S200 to S218 are repeated for each frame.

### D. Details of Processes in Initial Model Construction Stage

In the initial model construction stage of information processing system 1 according to the present embodiment, the initial model for reproducing a 3D model is constructed by capturing the person. The constructed initial model reflects information of the body and face of the person.

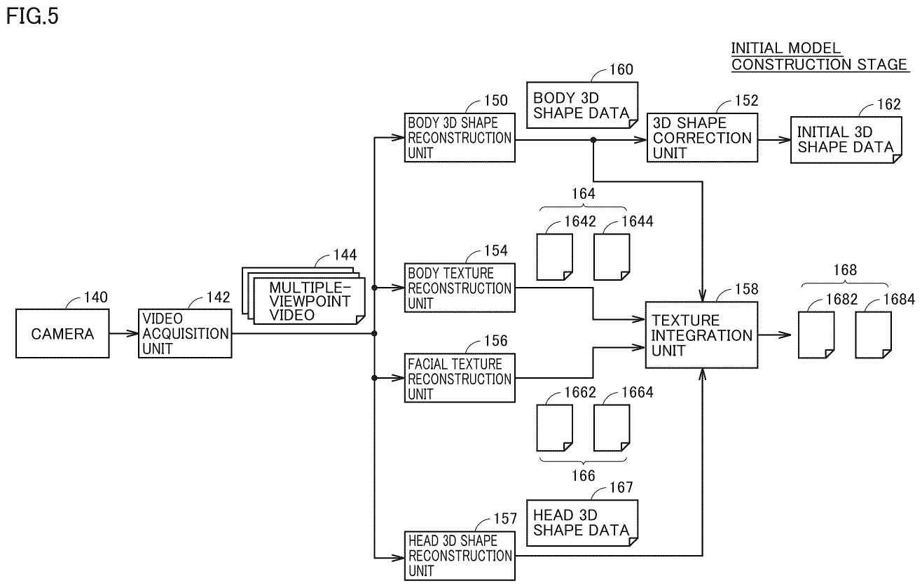

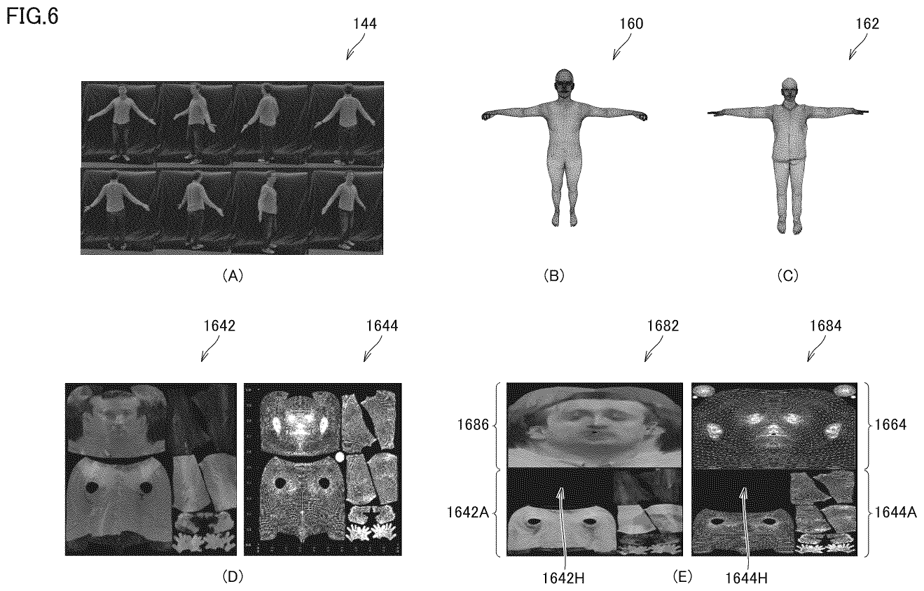

FIG. 5 is a schematic diagram showing a functional configuration example for implementing the initial model construction stage of information processing system 1 according to the present embodiment. FIG. 6 is a diagram showing exemplary data generated in the initial model construction stage of information processing system 1 according to the present embodiment.

Each function shown in FIG. 5 is typically implemented by the processor of information processing device 100 executing a program (initial model construction program 122 shown in FIG. 2). Referring to FIG. 5, information processing device 100 includes a video acquisition unit 142, a body 3D shape reconstruction unit 150, a 3D shape correction unit 152, a body texture reconstruction unit 154, a facial texture reconstruction unit 156, a head 3D shape reconstruction unit 157, and a texture integration unit 158.

### d1: Video Acquisition Unit 142

Video acquisition unit 142 acquires a 2D video captured by camera 140. On this occasion, video acquisition unit 142 acquires a plurality of 2D videos (multiple-viewpoint videos 144) in which the person, who is a target for which the 3D model is to be reproduced, is captured from a plurality of viewpoints. The capturing may be performed from a plurality of viewpoints with the position of camera 140 being changed with respect to the person, or the capturing may be performed from a plurality of viewpoints in such a manner that the person turns the person's body with camera 140 being fixed. Alternatively, a plurality of cameras 140 may be prepared, and the person may be captured using cameras 140, thereby acquiring a plurality of 2D videos. FIG. 6(A) shows exemplary multiple-viewpoint videos 144 obtained by capturing the person from eight viewpoints.

It should be noted that multiple-viewpoint videos 144 used to reconstruct the initial model are preferably constituted of 2D videos corresponding to 5 to 10 frames.

### d2: Body 3D Shape Reconstruction Unit 150

Body 3D shape reconstruction unit 150 reconstructs the 3D shape of the body based on multiple-viewpoint videos 144. That is, body 3D shape reconstruction unit 150 reconstructs the 3D shape of the body from the plurality of 2D videos of the person captured by camera 140, and outputs body 3D shape data 160 indicating the 3D shape of the captured body. FIG. 6(B) shows an example in which reconstructed body 3D shape data 160 is visually expressed.

More specifically, from the 2D videos, body 3D shape reconstruction unit 150 reconstructs a model indicating the 3D shape of the body of the person. A known algorithm such as “Tex2Shape” (Alldieck, T.; Pons-Moll, G.; Theobalt, C.; Magnor, M. Tex2Shape: Detailed Full Human Body Geometry From a Single Image. In 2019 IEEE/CVF International Conference on Computer Vision (ICCV); 2019; pp 2293-2303.

https://doi.org/10.1109/ICCV.2019.00238.) can be used to reconstruct such data indicating a 3D shape.

“Tex2Shape” outputs a shape parameter (main component feature β indicating the shape) and a displacement map. It should be noted that when “Tex2Shape” outputs a model in an SMPL format, the model may be further converted into an SMPL-X format having a resolution four times as large as that of the SMPL format.

Body 3D shape reconstruction unit 150 outputs body 3D shape data 160 as information indicating the 3D shape of the body of the person. Body 3D shape data 160 is typically constituted of data in a mesh format.

### d3: 3D Shape Correction Unit 152

3D shape correction unit 152 flattens the face region of body 3D shape data 160 reconstructed by body 3D shape reconstruction unit 150. Since another model is used to reproduce the face of the person in the 3D model reproduction stage, it is preferable that the face region of the reconstructed 3D shape is not modified.

Therefore, 3D shape correction unit 152 corrects, into a flat region, a region in the displacement map corresponding to the estimated face region. That is, 3D shape correction unit 152 corrects the face region into a flat region involving no undulations. By such flattening, a process of reproducing the head of the person in the 3D model reproduction stage can be performed more efficiently.

More specifically, 3D shape correction unit 152 extracts the person included in the 2D videos used to reconstruct body 3D shape data 160, and estimates a human body region (body part) of the extracted person. For example, a region corresponding to the face, hand, foot, or the like of the person is estimated. A known algorithm such as “DensePose” (Gueler, R. A.; Neverova, N.; Kokkinos, I. DensePose: Dense Human Pose Estimation in the Wild. In 2018 IEEE/CVF Conference on Computer Vision and Pattern Recognition; 2018; pp 7297-7306. https://doi.org/10.1109/CVPR.2018.00762.) can be used to estimate such a human body region.

Then, 3D shape correction unit 152 updates, to a value indicating the flat region, a value of the region in the displacement map corresponding to the estimated face region.

Further, since a finger or the like of a person is readily modeled as a variation region, it is preferable to correct the finger or the like into a flat region.

Finally, 3D shape correction unit 152 outputs initial 3D shape data 162 indicating the 3D shape in which the face region is flattened. FIG. 6(C) shows an example in which initial 3D shape data 162 is visually expressed.

### d4: Body Texture Reconstruction Unit 154

Body texture reconstruction unit 154 reconstructs the texture of the body from the plurality of 2D videos (multiple-viewpoint videos 144) of the person captured by camera 140. More specifically, body texture reconstruction unit 154 reconstructs body texture image 1642 and body texture map 1644. Body texture image 1642 and body texture map 1644 may be collectively referred to as “body texture data 164”.

FIG. 6(D) shows examples of body texture image 1642 and body texture map 1644 (body texture data 164).

Body texture reconstruction unit 154 reconstructs body texture data 164 in accordance with the following processes.

First, body texture reconstruction unit 154 detects a key point of the person from the 2D videos included in multiple-viewpoint videos 144. A known algorithm such as “OpenPose” (Cao, Z.; Hidalgo, G.; Simon, T.; Wei, S.-E.; Sheikh, Y. OpenPose: Realtime Multi-Person 2D Pose Estimation Using Part Affinity Fields. IEEE Transactions on Pattern Analysis and Machine Intelligence 2021, 43 (1), 172-186. https://doi.org/10.1109/TPAMI.2019.2929257.) can be used to detect such a key point.

Next, body texture reconstruction unit 154 estimates the human body region (body part) of the person by performing semantic segmentation onto the 2D videos using the detected key point. For such semantic segmentation, a known algorithm such as “PGN” (Gong, K.; Liang, X.; Li, Y.; Chen, Y.; Yang, M.; Lin, L. Instance-Level Human Parsing via Part Grouping Network. In Computer Vision-ECCV 2018; Ferrari, V., Hebert, M., Sminchisescu, C., Weiss, Y., Eds.; Lecture Notes in Computer Science; Springer International Publishing: Cham, 2018; pp 805-822. https://doi.org/10.1007/978-3-030-01225-0_47.) can be used.

Finally, body texture reconstruction unit 154 reconstructs the texture data (body texture image 1642 and body texture map 1644) from the plurality of 2D videos (multiple-viewpoint videos 144) by using the estimated human body region. A known algorithm such as “Semantic Human Texture Stitching” (Alldieck, T.; Magnor, M.; Xu, W.; Theobalt, C.; Pons-Moll, G. Detailed Human Avatars from Monocular Video. In 2018 International Conference on 3D Vision (3DV); 2018; pp 98-109. https://doi.org/10.1109/3DV.2018.00022.) can be used to reconstruct such texture data.

In the “Semantic Human Texture Stitching”, the texture data can be output in either of the SMPL format and the SMPL-X format. As described above, when body 3D shape data 160 conforming to the SMPL-X format is used, texture data also conforming to the SMPL-X format is used.

Here, the SMPL format/SMPL-X format employs the same format as that employed by the texture map (UV mapping) included in the texture data.

### d5: Facial Texture Reconstruction Unit 156

Facial texture reconstruction unit 156 reconstructs the texture of the face from the 2D videos of the person captured by camera 140. In the initial model construction stage, facial texture reconstruction unit 156 reconstructs the texture of the face based on the 2D videos included in multiple-viewpoint videos 144. More specifically, facial texture reconstruction unit 156 reconstructs a facial texture image 1662 and a facial texture map 1664. Facial texture image 1662 and facial texture map 1664 may be collectively referred to as “facial texture data 166”. Since the facial texture image is reconstructed by texture integration unit 158 as described later, facial texture image 1662 reconstructed by facial texture reconstruction unit 156 may be discarded.

Facial texture reconstruction unit 156 reconstructs facial texture data 166 in accordance with the following processes. That is, a known algorithm such as “DECA” (Feng, Y.; Feng, H.; Black, M. J.; Bolkart, T. Learning an Animatable Detailed 3D Face Model from In-the-Wild Images. ACM Trans. Graph. 2021, 40 (4), 88:1-88:13.

https://doi.org/10.1145/3450626.3459936.) can be used.

“DECA” outputs a FLAME model parameter (indicating the shape and facial expression of the face) for reproducing the face of the person, and outputs texture data conforming to the FLAME format. As described above, facial texture data 166 conforming to the FLAME format is output from the 2D videos of the person captured by the camera. As described later, texture integration unit 158 applies, to body texture data 164, facial texture data 166 conforming to the FLAME format, thereby integrating them.

It should be noted that also in the 3D model reproduction stage, facial texture reconstruction unit 156 reconstructs facial texture data 166 per frame.

### d6: Head 3D Shape Reconstruction Unit 157

Head 3D shape reconstruction unit 157 reconstructs the 3D shape of the head from the plurality of 2D videos (multiple-viewpoint videos 144) of the person captured by camera 140. That is, head 3D shape reconstruction unit 157 reconstructs head 3D shape data 167 indicating the 3D shape of the captured head.

Head 3D shape reconstruction unit 157 reconstructs a model indicating the 3D shape of the head of the person from the 2D videos, by using the same algorithm as that used by body 3D shape reconstruction unit 150. Head 3D shape reconstruction unit 157 outputs head 3D shape data 167 as information indicating the 3D shape of the head. Head 3D shape data 167 is typically constituted of data in a mesh format.

### d7: Texture Integration Unit 158

Texture integration unit 158 integrates body texture data 164 and facial texture data 166 so as to reconstruct initial texture data 168 (initial texture image 1682 and initial texture map 1684). Texture integration unit 158 integrates body texture data 164 and facial texture data 166 based on correspondence between body 3D shape data 160 and head 3D shape data 167.

As shown in FIG. 6(E), each of initial texture image 1682 and initial texture map 1684 is constituted of: a portion relating to the head including the face; and a portion of the body other than the head.

More specifically, initial texture image 1682 is constituted of: initial facial texture image 1686 reconstructed by below-described processes; and a corrected body texture image 1642A obtained by invalidating, from body texture image 1642, a partial head image 1642H corresponding to the head.

Initial texture map 1684 is constituted of: facial texture map 1664; and a corrected body texture map 1644A obtained by invalidating, from body texture map 1644, partial head map 1644H corresponding to the head.

As shown in FIG. 6(E), initial texture data 168 (texture data) includes: the texture image (corrected body texture image 1642A) corresponding to the reconstructed 3D shape of the body, and the texture image (initial facial texture image 1686) corresponding to the reconstructed 3D shape of the face; and the texture map (corrected body texture map 1644A) corresponding to the reconstructed 3D shape of the body, and the texture map (facial texture map 1664) corresponding to the reconstructed 3D shape of the face.

It should be noted that FIG. 6(E) shows a state in which partial head image 1642H and partial head map 1644H are deleted as an example of invalidating them; however, partial head image 1642H and partial head map 1644H does not need to be necessarily deleted, and may be set so as not to be used for the processes.

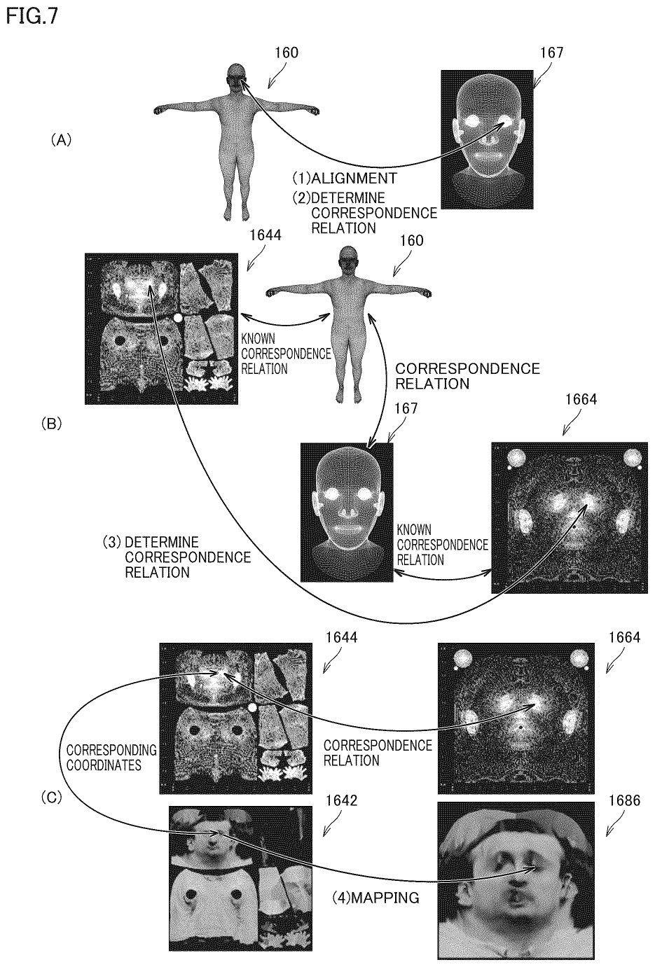

FIG. 7 is a schematic diagram for illustrating processes for texture integration in the initial model construction stage of information processing system 1 according to the present embodiment. Texture integration unit 158 performs the following five processes. cl (1) Alignment between Body 3D Shape Data 160 and Head 3D Shape Data 167

Texture integration unit 158 aligns the two pieces of shape data by mapping body 3D shape data 160 and head 3D shape data 167 to a common 3D space. Here, since body 3D shape data 160 and head 3D shape data 167 indicate the 3D shapes reconstructed from the same person, body 3D shape data 160 and head 3D shape data 167 are considered to have substantially the same topology.

Texture integration unit 158 focuses attention on common characteristic portions (eyes, nose, and the like) of the face therebetween, and maps the respective pieces of shape data in the common 3D space such that the portions on which attention is focused have the same coordinates. In the process of implementing such alignment, a coordinate transformation matrix including calculations such as transition, rotation, and scale is used.

### (2) Determination of Correspondence Relation between Meshes

Next, texture integration unit 158 determines correspondence between meshes in the two pieces of aligned shape data. That is, texture integration unit 158 determines correspondence between meshes (for example, a set of triangles each defined by three vertices) included in body 3D shape data 160 and meshes included in head 3D shape data 167.

More specifically, for each mesh included in aligned body 3D shape data 160, texture integration unit 158 searches for a closest mesh among the meshes included in aligned head 3D shape data 167. Finally, texture integration unit 158 determines correspondence between meshes (for example, a matrix indicating correspondence between an index indicating each mesh included in body 3D shape data 160 and an index indicating each mesh included in head 3D shape data 167).

In this way, texture integration unit 158 determines the correspondence between the reconstructed 3D shape of the body (body 3D shape data 160) and the reconstructed 3D shape of the head (head 3D shape data 167).

### (3) Determination of Correspondence Relation Between Texture Maps

Next, texture integration unit 158 determines correspondence between body texture map 1644 and facial texture map 1664.

The correspondence (one-to-one) between body 3D shape data 160 and body texture map 1644 is known, and similarly, the correspondence (one-to-one) between head 3D shape data 167 and facial texture map 1664 is also known. Since the correspondence (one-to-one) between body 3D shape data 160 and head 3D shape data 167 is determined by the above-described process, texture integration unit 158 determines the correspondence between the texture maps using the correspondence between the pieces of shape data.

Thus, based on the determined correspondence between the 3D shapes, texture integration unit 158 determines the correspondence between the texture map (body texture map 1644) corresponding to the 3D shape of the body (body 3D shape data 160) and the texture map (facial texture map 1664) corresponding to the 3D shape of the head (head 3D shape data 167).

### (4) Generation of Initial Facial Texture Image

Next, texture integration unit 158 generates initial facial texture image 1686 based on the correspondence between body texture map 1644 and facial texture map 1664.

More specifically, texture integration unit 158 determines the coordinates of body texture map 1644 corresponding to the coordinates of facial texture map 1664, and applies, as a new pixel value of the facial texture image, a pixel value of body texture image 1642 at the determined coordinates of body texture map 1644. That is, initial facial texture image 1686, which is a new facial texture image, is generated by mapping body texture image 1642 based on the correspondence between body texture map 1644 and facial texture map 1664.

Thus, based on the determined correspondence between the texture maps, texture integration unit 158 generates the texture image (initial facial texture image 1686) corresponding to the 3D shape of the head (head 3D shape data 167) from the texture image (body texture image 1642) corresponding to the 3D shape of the body (body 3D shape data 160).

### (5) Data Integration

Finally, texture integration unit 158 reconstructs initial texture data 168 (initial texture image 1682 and initial texture map 1684).

More specifically, texture integration unit 158 invalidates partial head image 1642H corresponding to the head in body texture image 1642 and combines it with the generated initial facial texture image 1686. Initial texture image 1682 corresponds to a texture image obtained by adjusting corrected body texture map 1644A and initial facial texture image 1686 on the same scale and arranging them adjacent to each other.

Further, texture integration unit 158 invalidates partial head map 1644H corresponding to the head in body texture map 1644 and combines it with facial texture map 1664. Initial texture map 1684 corresponds to a texture map obtained by adjusting corrected body texture image 1642A and facial texture map 1664 on the same scale and arranging them adjacent to each other.

It should be noted that in the case of the texture data conforming to the SMPL-X format, the texture data can be re-formatted to the FLAME format by predetermined scaling. That is, since the correspondence between the texture map conforming to the SMPL-X format and the texture map conforming to the FLAME format is a one-to-one relation, a magnification or the like when enlarging the texture image can be uniquely determined based on the correspondence between the formats.

Thus, texture integration unit 158 integrates the texture image (body texture image 1642) corresponding to the 3D shape of the body (body 3D shape data 160) and the texture image (initial facial texture image 1686) corresponding to the 3D shape of the head (head 3D shape data 167), and integrates the texture map (corrected body texture map 1644A) corresponding to the 3D shape of the body and the texture map (facial texture map 1664) corresponding to the 3D shape of the head, thereby generating initial texture data 168.

Initial texture data 168 (initial texture image 1682 and initial texture map 1684) is constituted of: a portion relating to the head including the face; and a portion of the body other than the head. By preparing a larger number of textures for the head including the face, reproducibility of facial expression and motion (gesture) can be improved even in the case of capturing using one camera.

With the above-described processes, the process of constructing an initial model is completed.

### E. Details of Processes in 3D Model Reproduction Stage

In the 3D model reproduction stage of information processing system 1 according to the present embodiment, the 3D model is reproduced from the 2D video (corresponding to one frame) of the person captured by one camera 140. By updating the 3D model per frame of the 2D video, a change in motion or facial expression of the person can be reproduced as a motion picture.

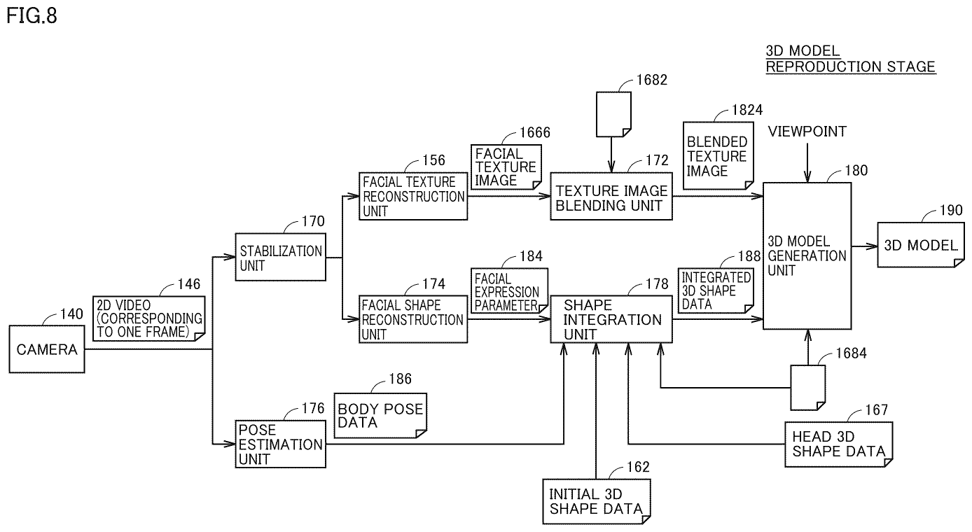

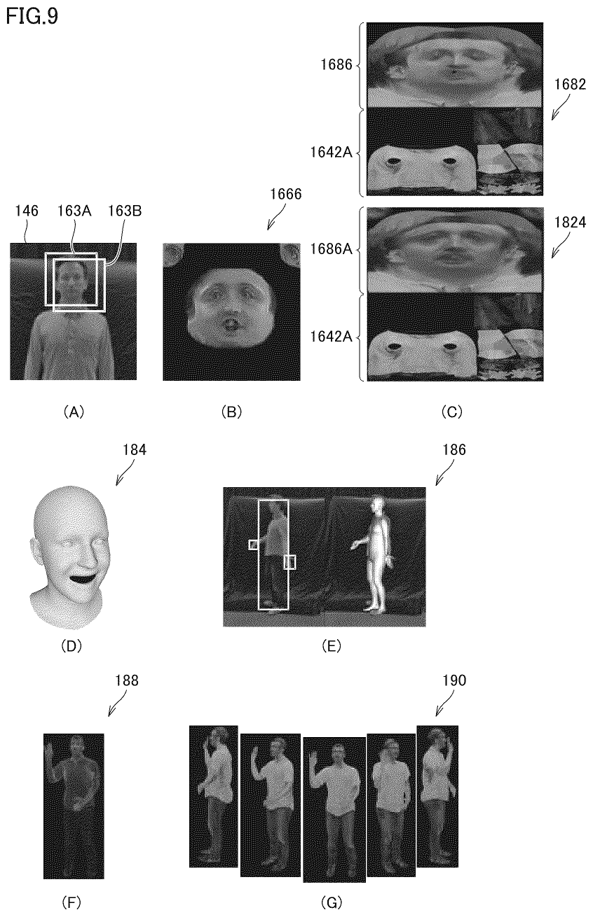

FIG. 8 is a schematic diagram showing a functional configuration example for implementing the 3D model reproduction stage of information processing system 1 according to the present embodiment. FIG. 9 is a diagram showing exemplary data generated in the 3D model reproduction stage of information processing system 1 according to the present embodiment.

Each function shown in FIG. 8 is typically implemented by the processor of information processing device 100 executing a program (3D model reproduction program 124 shown in FIG. 2). It should be noted that part of the process may be performed by information processing device 200.

Referring to FIG. 8, information processing device 100 includes a stabilization unit 170, facial texture reconstruction unit 156, a texture image blending unit 172, a facial shape reconstruction unit 174, a pose estimation unit 176, a shape integration unit 178, and a 3D model generation unit 180.

### e1: Stabilization Unit 170

Stabilization unit 170 detects a face region included in the 2D video captured by camera 140, and temporally stabilizes the detected face region. Stabilization unit 170 outputs, to each of facial texture reconstruction unit 156 and facial shape reconstruction unit 174, a partial video corresponding to the temporally stabilized face region. That is, the partial video corresponding to the window set in the 2D video of the person captured by camera 140 is input to each of facial texture reconstruction unit 156 and facial shape reconstruction unit 174.

Stabilization unit 170 temporally smoothes the position and size of face region 163 (window) extracted from 2D video 146. FIG. 9(A) shows an exemplary process of extracting face regions 163A, 163B from 2D video 146. The ranges of face regions 163A, 163B can be determined by a known image recognition process.

It is assumed that a known algorithm such as “DECA” described above is used to reproduce the face of the person per frame. “DECA” can reproduce the face per frame; however, when the size and position of face region 163 are determined per frame, fluctuation or discontinuity may occur in the reproduced face as viewed between frames.

In general, since the position of a key point (for example, eye) of the face detected from the 2D video (corresponding to one frame) can be changed among frames, the position and size of the window determined based on the detected key point can be also changed among the frames.

To address this, stabilization unit 170 stabilizes the reproduced face by temporally smoothing the position and size of the window. That is, stabilization unit 170 temporally smoothes the position of the person in the 2D video so as to set the window.

More specifically, stabilization unit 170 employs a window having a certain size to cover the entire face of the person, and sets the window at a position based on a specific key point as a reference. For example, the window can be set to be centered on the tip of the nose.

For example, when the person moves, in the next frame, within the window set in the preceding frame, stabilization unit 170 sets the position of the window in the next frame based on, as a reference, the average position of the specific key point detected from past n frames.

When the person moves close to or moves away from camera 140 in the next frame, stabilization unit 170 correspondingly changes the size of the window based on the moving average of the size of the window in the past n frames.

With such a process, a degree of occurrence of discontinuity among the frames can be reduced when the window is caused to follow the movement of the person in 2D video 146.

It should be noted that when the person moves too fast and accordingly moves out of the window, the size and position of the window are reset and set again. Since discontinuity can occur in the reproduced face in this case, an additional process for reducing a sense of incongruity may be performed.

By employing the above-described process, the position and size of face region 163 (window) sequentially extracted are not greatly changed among the frames, thereby reducing the discontinuity in the reconstructed shape of the face.

### e2: Facial Texture Reconstruction Unit 156

Facial texture reconstruction unit 156 reconstructs the texture of the face based on the video of face region 163 extracted from 2D video 146. More specifically, facial texture reconstruction unit 156 reconstructs facial texture image 1666. Facial texture reconstruction unit 156 is substantially the same as facial texture reconstruction unit 156 shown in FIG. 5, and therefore will not be described in detail repeatedly. FIG. 9(B) shows an example of reconstructed facial texture image 1666.

It should be noted that facial texture reconstruction unit 156 also reconstructs the facial texture map, but the facial texture map may be discarded because the facial texture map is not necessarily required in texture image blending unit 172.

### e3: Texture Image Blending Unit 172

Texture image blending unit 172 blends initial texture image 1682 reconstructed in the initial model construction stage and facial texture image 1666 reconstructed by facial texture reconstruction unit 156, so as to reconstruct a blended facial texture image 1824. That is, texture image blending unit 172 blends, with the texture image (reconstructed facial texture image 1666) of the reconstructed face, the texture image (initial texture image 1682) included in the texture data (initial texture data 168), so as to reconstruct the texture image (blended facial texture image 1824) of the person captured by camera 140.

FIG. 9(C) shows an exemplary reconstructed blended facial texture image 1824.

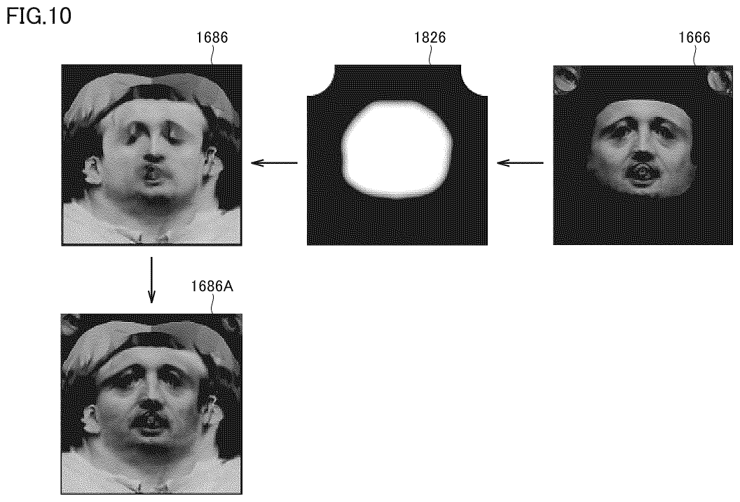

FIG. 10 is a schematic diagram for illustrating the blending process in information processing system 1 according to the present embodiment. Referring to FIG. 10, texture image blending unit 172 blends initial facial texture image 1686 of initial texture image 1682 (initial facial texture image 1686 and corrected body texture image 1642A) with facial texture image 1666 using a mask 1826, thereby generating a corrected facial texture image 1686A.

That is, by performing the blending process for initial facial texture image 1686 of initial texture image 1682, blended facial texture image 1824 is generated. On this occasion, texture image blending unit 172 superimposes, on initial facial texture image 1686, a result of passage of facial texture image 1666 through mask 1826. Thus, texture image blending unit 172 superimposes, on initial facial texture image 1686 included in initial texture data 168, the result of passage, through the mask, of the texture image (blended facial texture image 1824) of the person captured by camera 140.

Mask 1826 may be generated by assigning, as an intensity (degree of passage), a degree of reliability of each pixel of facial texture data 166 reconstructed by facial texture reconstruction unit 156, for example.

Alternatively, mask 1826 may be generated based on facial texture image 1666. More specifically, among the pixels included in facial texture image 1666, a pixel having a pixel value more than a predetermined threshold value is assigned with “1” (passage), and the other pixels are assigned with “0” (block). Then, a minimization filter is applied using a square window, and a blurring filter (for example, a Gaussian filter or a box filter) is further applied to an edge.

By using such a mask 1826, the blending can be implemented such that the periphery of facial texture image 1666 superimposed on initial facial texture image 1686 is gradually changed. That is, mask 1826 is configured to continuously change the degree of passage.

With such blending, the facial expression reflecting the video of the current frame can be reproduced in real time, whereas a hairstyle or the like can be stably reproduced using initial texture image 1682.

That is, in the 3D model reproduction stage, information such as the facial expression reconstructed from the video of each frame is used to be reflected in the 3D model in real time, whereas for the texture of the region that is other than the face region in the head and that is not necessarily reconstructed from the video of the frame, the information of initial facial texture image 1686 is reflected in the 3D model.

### e4: Facial Shape Reconstruction Unit 174

Facial shape reconstruction unit 174 reconstructs parameters (facial expression parameters 184) respectively indicating the facial expression, motion, and 3D shape of the face based on the video of face region 163 extracted from 2D video 146. That is, facial shape reconstruction unit 174 corresponds to a facial shape reconstruction unit that reconstructs the 3D shape of the face from the 2D video of the person captured by camera 140. For facial shape reconstruction unit 174, a known algorithm such as “DECA” described above may be employed.

FIG. 9(D) shows an example in which the parameters (facial expression parameters 184) respectively indicating the facial expression, motion, and 3D shape of the reconstructed face are visually expressed.

### e5: Pose Estimation Unit 176

Pose estimation unit 176 estimates the pose (posture) of the body per frame from 2D video 146. That is, pose estimation unit 176 estimates the pose of the person from the 2D video of the person captured by camera 140. Body pose data 186 is output from pose estimation unit 176 per frame. Typically, body pose data 186 includes information such as an angle of each joint. It should be noted that a known pose estimation algorithm can be employed for pose estimation unit 176.

FIG. 9(E) shows an example in which the process of estimating a pose and estimated body pose data 186 are visually expressed.

### e6: Shape Integration Unit 178

Shape integration unit 178 reconstructs the 3D shape of the body corresponding to captured 2D video 146 by inputting body pose data 186 and facial expression parameters 184 into initial 3D shape data 162 reconstructed in the initial model construction stage.

More specifically, based on initial 3D shape data 162, shape integration unit 178 reconstructs the 3D shape of the body corresponding to the pose designated by body pose data 186 and the facial expression defined by facial expression parameter 184. Thus, integrated 3D shape data 188 indicating a 3D shape obtained by integrating the 3D shape of the body and the 3D shape of the face is reconstructed.

Further, shape integration unit 178 may reconstruct integrated 3D shape data 188 using not only initial 3D shape data 162 but also 3D shape data obtained by incorporating head 3D shape data 167 into initial 3D shape data 162.

Further, shape integration unit 178 may determine correspondence based on initial texture map 1684 (corrected body texture map 1644A and facial texture map 1664), and then may integrate the 3D shape of the body and the 3D shape of the face.

In this way, shape integration unit 178 reconstructs the 3D shape of the body corresponding to the estimated pose based on initial 3D shape data 162 (3D shape data), and integrates the reconstructed 3D shape of the body and the reconstructed 3D shape of the face that is based on facial expression parameters 184 so as to reconstruct the 3D shape (integrated 3D shape data 188) of the person captured by camera 140. Further, since shape integration unit 178 integrates the reconstructed 3D shape of the body and the reconstructed 3D shape of the face based on the texture map (initial texture map 1684) included in initial texture data 168, accuracy in reproduction can be improved.

FIG. 9(F) shows an example in which reconstructed integrated 3D shape data 188 is visually expressed.

### e7: 3D Model Generation Unit 180

3D model generation unit 180 integrates the 3D shape that is based on integrated 3D shape data 188, and blended facial texture image 1824. Further, 3D model generation unit 180 outputs 3D model 190 viewed from the designated viewpoint.

Thus, based on the 3D shape (integrated 3D shape data 188) of the person captured by camera 140 and the texture image (blended facial texture image 1824) of the person captured by camera 140, 3D model generation unit 180 generates 3D model 190 of the person captured by camera 140.

It should be noted that reference may be made to initial texture map 1684 in combining integrated 3D shape data 188 and blended facial texture image 1824 (mapping the texture images). That is, 3D model generation unit 180 may integrate the 3D shape of the person (integrated 3D shape data 188) and the texture image of the person (blended facial texture image 1824) based on initial texture map 1684 included in initial texture data 168 (texture data).

FIG. 9(F) shows an example in which a state of 3D model 190 as viewed from a plurality of viewpoints is visually expressed. It should be noted that 3D model generation unit 180 may not simultaneously display the 3D model viewed from the plurality of viewpoints as shown in FIG. 9(F), and outputs the 3D model viewed from one designated viewpoint.

### F. Modification

Although it has been illustratively described that the process (initial model construction stage) of constructing an initial model and the process (3D model reproduction stage) of generating a 3D model are performed by the same information processing device 100; however, part of the processes may be performed by another information processing device.

Further, the initial model (initial 3D shape data 162 and initial texture data 168) may be constructed in advance, and may be appropriately used at a stage in which reproduction of the 3D model is required.

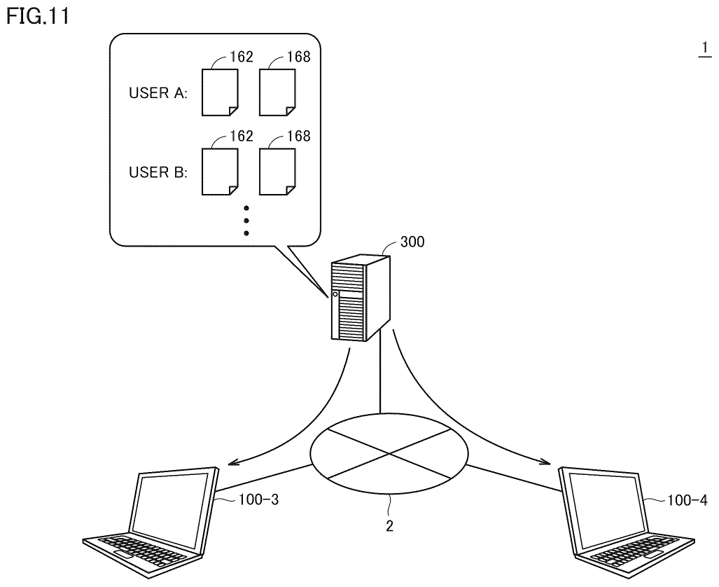

FIG. 11 is a schematic diagram showing another example of the system configuration of information processing system 1 according to the present embodiment. Referring to FIG. 11, for example, server device 300 holds initial 3D shape data 162 and initial texture data 168 in advance for each user.

Server device 300 provides designated initial 3D shape data 162 and initial texture data 168 in response to a request from each of information processing devices 100-3, 100-4. Each of information processing devices 100-3, 100-4 performs the process (3D model reproduction stage) of generating a 3D model using initial 3D shape data 162 and initial texture data 168 provided from server device 300.

It should be noted that initial 3D shape data 162 and initial texture data 168 may not be necessarily prepared based on the 2D videos obtained by capturing the user who uses information processing device 100. Since the reconstructed texture image of the captured person is blended in the 3D model reproduction stage as described above, the 3D model of the person can be also reproduced using initial 3D shape data 162 and initial texture data 168 generated from a different person.

Further, information processing devices 100-1, 100-2 and information processing device 200 shown in FIG. 1 may be cooperated to perform the process (initial model construction stage) of constructing an initial model and the process (3D model reproduction stage) of generating a 3D model. A process to be performed by each of the information processing devices can be appropriately designed.

### G. Summary

When reproducing the 3D model, information processing system 1 according to the present embodiment can generate the 3D model of the person from the 2D video corresponding to one frame instead of a plurality of 2D videos captured by a plurality of cameras. By reconstructing the shape and texture of each of the body and face, facial expression and gesture can be reproduced with higher accuracy.

Further, when reproducing the 3D model, the 3D model can be generated from the 2D video corresponding to one frame and captured by the camera, and therefore a processing load can be reduced as compared with a case where a plurality of 2D videos captured by a plurality of cameras are used, with the result that the 3D model can be reproduced in real time.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

1. An information processing system comprising:
a camera;
a storage unit that stores 3D shape data and texture data each prepared in advance, the 3D shape data indicating a 3D shape of a body, the texture data indicating a texture of the body;
a facial texture reconstruction unit that reconstructs a texture of a face from a 2D video of a person captured by the camera;
a facial shape reconstruction unit that reconstructs a 3D shape of the face from the 2D video of the person captured by the camera;
a pose estimation unit that estimates a pose of the person from the 2D video of the person captured by the camera;
a shape integration unit that reconstructs a 3D shape of the body corresponding to the estimated pose based on the 3D shape data and that integrates the reconstructed 3D shape of the body and the reconstructed 3D shape of the face so as to reconstruct a 3D shape of the person captured by the camera;
a texture reconstruction unit that reconstructs a texture image of the person captured by the camera by blending, with an image of the reconstructed texture of the face, a texture image included in the texture data; and
a model generation unit that generates, based on the 3D shape of the person captured by the camera and the texture image of the person captured by the camera, a 3D model of the person captured by the camera.

2. The information processing system according to claim 1, wherein the texture data includes:
a texture image corresponding to the reconstructed 3D shape of the body and a texture image corresponding to the reconstructed 3D shape of the face, and
a texture map corresponding to the reconstructed 3D shape of the body and a texture map corresponding to the reconstructed 3D shape of the face,
the information processing system further comprising:
a body shape reconstruction unit that reconstructs the 3D shape of the body from a plurality of 2D videos of the person captured by the camera;
a body texture reconstruction unit that reconstructs the texture of the body from the plurality of 2D videos of the person captured by the camera;
a head shape reconstruction unit that reconstructs a 3D shape of a head from the plurality of 2D videos of the person captured by the camera; and
a texture integration unit that determines correspondence between the reconstructed 3D shape of the body and the reconstructed 3D shape of the head, that determines, based on the determined correspondence between the 3D shapes, a correspondence between the texture map corresponding to the 3D shape of the body and the texture map corresponding to the 3D shape of the head, and that generates, based on the determined correspondence between the texture maps, a texture image corresponding to the 3D shape of the head from the texture image corresponding to the 3D shape of the body.

3. The information processing system according to claim 2, wherein the shape integration unit integrates the reconstructed 3D shape of the body and the reconstructed 3D shape of the face based on the texture maps included in the texture data.

4. The information processing system according to claim 2, wherein the model generation unit integrates the 3D shape of the person and the texture image of the person based on the texture maps included in the texture data.

5. The information processing system according to claim 1, wherein the texture reconstruction unit superimposes, on the texture image included in the texture data, a result of passage, through a mask, of the texture image of the person captured by the camera.

6. The information processing system according to claim 1, wherein
a partial video corresponding to a window set in the 2D video of the person captured by the camera is input to each of the facial texture reconstruction unit and the facial shape reconstruction unit,
the information processing system further comprising a stabilization unit that temporally smoothes a position of the person in the 2D video so as to set the window.

7. An information processing method comprising:
reconstructing a texture of a face from a 2D video of a person captured by a camera;
reconstructing a 3D shape of the face from the 2D video of the person captured by the camera;
estimating a pose of the person from the 2D video of the person captured by the camera;
reconstructing a 3D shape of the body corresponding to the estimated pose based on 3D shape data indicating a 3D shape of the body, the 3D shape data being prepared in advance;
integrating the reconstructed 3D shape of the body and the reconstructed 3D shape of the face so as to reconstruct a 3D shape of the person captured by the camera;
reconstructing a texture image of the person captured by the camera by blending, with an image of the reconstructed texture of the face, a texture image included in texture data indicating a texture of the body, the texture data being prepared in advance; and
generating, based on the 3D shape of the person captured by the camera and the texture image of the person captured by the camera, a 3D model of the person captured by the camera.

8. (canceled)

9. The information processing method according to claim 7, wherein the texture data includes:
a texture image corresponding to the reconstructed 3D shape of the body and a texture image corresponding to the reconstructed 3D shape of the face, and
a texture map corresponding to the reconstructed 3D shape of the body and a texture map corresponding to the reconstructed 3D shape of the face,
the information processing method further comprising:
reconstructing the 3D shape of the body from a plurality of 2D videos of the person captured by the camera;
reconstructing the texture of the body from the plurality of 2D videos of the person captured by the camera;
reconstructing a 3D shape of a head from the plurality of 2D videos of the person captured by the camera;
determining correspondence between the reconstructed 3D shape of the body and the reconstructed 3D shape of the head, that determines, based on the determined correspondence between the 3D shapes, a correspondence between the texture map corresponding to the 3D shape of the body and the texture map corresponding to the 3D shape of the head; and
generating, based on the determined correspondence between the texture maps, a texture image corresponding to the 3D shape of the head from the texture image corresponding to the 3D shape of the body.

10. The information processing method according to claim 9, wherein the integrating the reconstructed 3D shape of the body and the reconstructed 3D shape of the face is based on the texture maps included in the texture data.

11. The information processing method according to claim 9, wherein the generating the 3D model comprises integrating the 3D shape of the person and the texture image of the person based on the texture maps included in the texture data.

12. The information processing method according to claim 7, wherein the reconstructing the image comprises superimposing, on the texture image included in the texture data, a result of passage, through a mask, of the texture image of the person captured by the camera.

13. The information processing method according to claim 7, wherein:
each of the reconstructing the texture of the face and the reconstructing a 3D shape of the face comprises utilizing a partial video corresponding to a window set in the 2D video of the person captured by the camera,
the information processing method further comprising temporally smoothing a position of the person in the 2D video so as to set the window.

14. A non-transitory storage medium storing computer-readable instructions that, when executed, causes one or more processor to perform operations comprising:
reconstructing a texture of a face from a 2D video of a person captured by a camera;
reconstructing a 3D shape of the face from the 2D video of the person captured by the camera;
estimating a pose of the person from the 2D video of the person captured by the camera;
reconstructing a 3D shape of the body corresponding to the estimated pose based on 3D shape data indicating a 3D shape of the body, the 3D shape data being prepared in advance;
integrating the reconstructed 3D shape of the body and the reconstructed 3D shape of the face so as to reconstruct a 3D shape of the person captured by the camera;
reconstructing a texture image of the person captured by the camera by blending, with an image of the reconstructed texture of the face, a texture image included in texture data indicating a texture of the body, the texture data being prepared in advance; and
generating, based on the 3D shape of the person captured by the camera and the texture image of the person captured by the camera, a 3D model of the person captured by the camera.

15. The non-transitory storage medium according to claim 14, wherein the texture data includes:
a texture image corresponding to the reconstructed 3D shape of the body and a texture image corresponding to the reconstructed 3D shape of the face, and
a texture map corresponding to the reconstructed 3D shape of the body and a texture map corresponding to the reconstructed 3D shape of the face,
the operations further comprising:
reconstructing the 3D shape of the body from a plurality of 2D videos of the person captured by the camera;
reconstructing the texture of the body from the plurality of 2D videos of the person captured by the camera;
reconstructing a 3D shape of a head from the plurality of 2D videos of the person captured by the camera;
determining correspondence between the reconstructed 3D shape of the body and the reconstructed 3D shape of the head, that determines, based on the determined correspondence between the 3D shapes, a correspondence between the texture map corresponding to the 3D shape of the body and the texture map corresponding to the 3D shape of the head; and
generating, based on the determined correspondence between the texture maps, a texture image corresponding to the 3D shape of the head from the texture image corresponding to the 3D shape of the body.

16. The non-transitory storage medium according to claim 15, wherein the integrating the reconstructed 3D shape of the body and the reconstructed 3D shape of the face is based on the texture maps included in the texture data.

17. The non-transitory storage medium according to claim 15, wherein the generating the 3D model comprises integrating the 3D shape of the person and the texture image of the person based on the texture maps included in the texture data.

18. The non-transitory storage medium according to claim 14, wherein the reconstructing the image comprises superimposing, on the texture image included in the texture data, a result of passage, through a mask, of the texture image of the person captured by the camera.

19. The non-transitory storage medium according to claim 14, wherein
each of the reconstructing the texture of the face and the reconstructing a 3D shape of the face comprises utilizing a partial video corresponding to a window set in the 2D video of the person captured by the camera,
the operations further comprising temporally smoothing a position of the person in the 2D video so as to set the window.
